(19) United States
(12) Patent Application Publication
(10) Pub. No.: US 2023/0324892 A1
(43) Pub. Date: Oct. 12, 2023

(54) CONTROL MANAGEMENT DEVICE

(71) Applicant: Mitsubishi Electric Corporation, Tokyo (JP)

(72) Inventors: Tatsuya NAGATANI, Tokyo (JP); Marina KOUSAKA, Tokyo (JP)

(73) Assignee: Mitsubishi Electric Corporation, Tokyo (JP)

(21) Appl. No.: 18/024,968

(22) PCT Filed: Nov. 18, 2020
(86) PCT No.: PCT/JP2020/043004

§ 371 Date: Mar. 7, 2023

(51) Int. Cl. G05B 19/418

(52) U.S. Cl. CPC G05B 19/41865; G05B 2219/32162

(57) ABSTRACT

The present disclosure relates to a control management device including a job input unit into which a job is input, a controller exclusive determination unit configured to determine whether or not the controller which is a target of an instruction included in the job is locked due to an ongoing exclusive process by another job, a parameter value storage configured to, when an instruction to be executed next is writing of an exclusive process, store a value of writing target in the controller as an original data value and lock the controller, an instruction execution unit configured to notify the controller of the instruction to be executed next in the job, a job completion determination unit configured to determine whether or not all instructions in the job have been completed, and a parameter value restoration unit configured to restore the original data value to the controller.

### TECHNICAL FIELD

The present disclosure relates to a control management device that manages control of equipment.

### BACKGROUND ART

In a conventional equipment management device, for example, as disclosed in Patent Document 1, a management device has been known in which, in terms of series of processes executed in a predetermined order, even if a plurality of series of processes are executed, data usage has been improved by compiling the data obtained in each series of processes by recording the start time and the end time of a series of processes.

### PRIOR ART DOCUMENTS

### Patent Document(s)

[Patent Document 1] Japanese Patent Application Laid-Open No. 2018-63541

### SUMMARY

### Problem to be Solved by the Invention

In a conventional management device, there has been a problem in that, when a plurality of series of processes that can be executed parallelly target the same device, if a process changes the parameter of the device, the device shows behavior different from expected in the other series of processes.

The present disclosure has been made to solve the above problem, and an object thereof is to provide a control management device capable of parallel execution of a plurality of series of processes.

### Means to Solve the Problem

According to the present disclosure, a control management device includes a job input unit into which a job including a plurality of instructions to a controller is input, a controller exclusive determination unit configured to determine whether or not the controller which is a target of an instruction included in the job is locked due to an ongoing exclusive process by another job, and, when the controller is locked, wait for the controller to be unlocked, a parameter value storage configured to, when an instruction to be executed next is writing of an exclusive process, store a value of writing target in the controller as an original data value and lock the controller, an instruction execution unit configured to notify the controller of the instruction to be executed next in the job and cause the instruction be executed by the controller, a job completion determination unit configured to determine whether or not all instructions in the job have been completed, and a parameter value restoration unit configured to restore the original data value to the controller after all the instructions in the job have been completed and unlock the controller.

### Effects of the Invention

According to the control management device according to the present disclosure, the exclusive process of parallelly executed jobs is ensured by locking the instruction target controller which the exclusive process is specified.

### BRIEF DESCRIPTION OF DRAWINGS

FIG. 1 A block diagram illustrating a schematic configuration of a management system incorporating a control management device of the present disclosure.

FIG. 2 A functional block diagram illustrating a configuration of a control management device according to a first embodiment.

FIG. 3 A flowchart illustrating a processing flow of the control management device according to the first embodiment.

FIG. 4 A functional block diagram illustrating a configuration of a control management device according to a second embodiment.

FIG. 5 A flowchart illustrating a processing flow of the control management device according to the second embodiment.

FIG. 6 A functional block diagram illustrating a configuration of a control management device according to a third embodiment.

FIG. 7 A flowchart illustrating a processing flow of the control management device according to the third embodiment.

FIG. 8 A functional block diagram illustrating a configuration of a control management device according to a fourth embodiment.

FIG. 9 A flowchart illustrating a processing flow of the control management device according to the fourth embodiment.

FIG. 10 A diagram illustrating a hardware configuration that implements vehicle control devices according to the first to fourth embodiments.

FIG. 11 A diagram illustrating a hardware configuration that implements the vehicle control devices according to the first to fourth embodiments.

### DESCRIPTION OF EMBODIMENT(S)

<Introduction>

A control management device according to the present disclosure is characterized by being incorporated into a management system for a plurality of manufacturing devices mainly installed in a production site such as a factory, and exclusively controlling the manufacturing devices. The conventional management system specialized in production control, and the entire system has been designed specifically for each factory. In other words, the main purpose is to manage the products produced in the entire factory, such as the items to be produced, the number of products produced, and the production status, and detailed maintenance information and the like for each manufacturing apparatus are not subject to management. Meanwhile, each manufacturing apparatus is equipped with a dedicated management program for the management system. In order for the management system to collect information other than information on production management from each manufacturing device, the management dedicated program of each manufacturing device is required to be called appropriately, and the processing order and processing timing throughout the system are built in.

However, with the generalization of Internet of Things (IoT) technology and communication protocols in factories, as well as the development of big data and Artificial Intelligence (AI) technology represented by preventive maintenance, the demand for collecting information on manufacturing devices is growing. However, in the conventional management system, the processing order and processing timing throughout the entire system were built in; therefore, there has been a problem that the high system repair cost would mount in order to meet all the requests for information collection in rapid increase.

For example, when large quantity data collection requests to the manufacturing devices are involved, an appropriate response to each data collection request fails, so it is required to appropriately manage the processing order. A specific example is that controllers of the manufacturing devices have limited resources for general-purpose data for communication with the management device, so the following processes are required to be consecutively executed.

Memory, which is readable by the management system, is caused to change the controller parameter to write the requested data. Then, after confirming that the requested data has been written to the memory, the management system reads the corresponding memory to implement data collection. A series of processes from changing the parameter specifying data to be written to the memory to reading the memory is required to be executed exclusively. If the parameter is changed before the memory is read, the behavior would be different from expected.

The control management device according to the present disclosure can make the addition of a new collection request to the management system facilitated by exclusively executing a series of requests to the manufacturing device, preventing the above behavior different from expected.

### FIRST EMBODIMENT

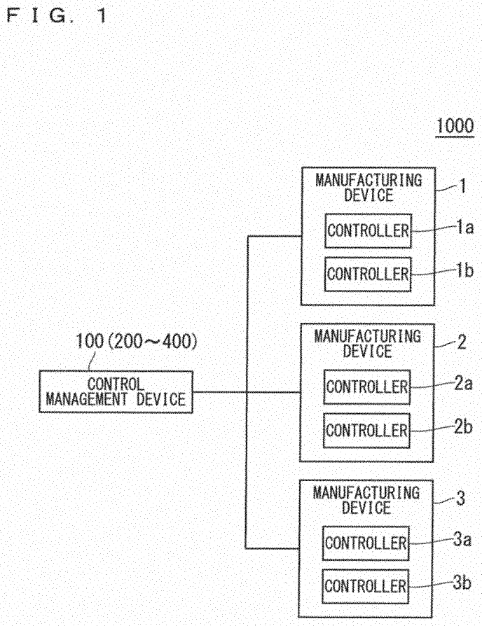

FIG. 1 is a block diagram illustrating a schematic configuration of a management system 100 incorporating a control management device according to the present disclosure.

As illustrated in FIG. 1, the management system 1000 is configured such that a control management device 100 manages the control in a manufacturing device 1, a manufacturing device 2, and a manufacturing device 3, where the manufacturing device 1 is controlled by controllers 1a and 1b, the manufacturing device 2 is controlled by controllers 2a and 2b, and the manufacturing device 3 is controlled by controllers 3a and 3b. The control management device 100 manages the control of the manufacturing devices 1 to 3 by communicating with the controllers 1a, 1b, 2a, 2b, 3a and 3b. In the following description, the controllers 1a, 1b, 2a, 2b, 3a and 3b are collectively referred to as controllers 1a to 3b for simplification.

The configuration of the management system 1000 is common to the first to fourth embodiments described below, and FIG. 1 is commonly used in the description of the first to fourth embodiments.

Also, the management system 1000 illustrated in FIG. 1 is an example, and the application of the present disclosure is not limited to the system in FIG. 1.

<Device Configuration>

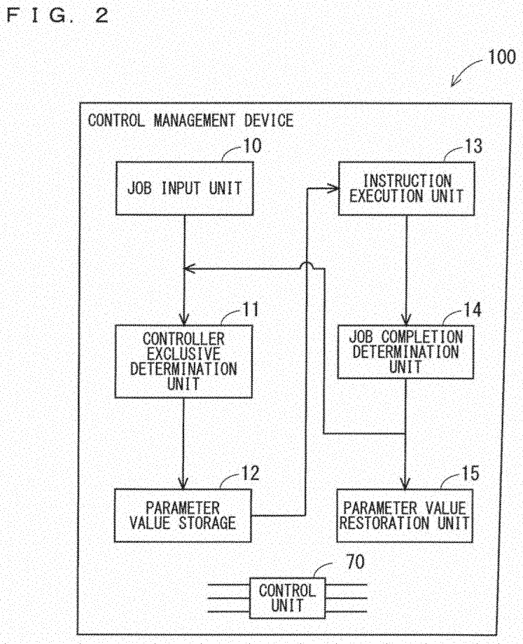

FIG. 2 is a functional block diagram illustrating a configuration of a control management device 100 of a first embodiment. As illustrated in FIG. 2, the control management device 100 includes a job input unit 10 that takes in a job including a series of instructions to the manufacturing devices 1 to 3 (FIG. 1), a controller exclusive determination unit 11 to which the job captured by the job input unit 10 is input, a parameter value storage 12 to which a determination result in the controller exclusive determination unit 11 is input, and an instruction execution unit 13 that executes the instructions included in the job. The control management device 100 further includes a job completion determination unit 14 that determines processing in the instruction execution unit 13, a parameter value restoration unit 15 that restores the parameter value to the state before change based on the determination result of the job completion determination unit 14, and a control unit 70 that controls each part in the control management device 100.

<Operation>

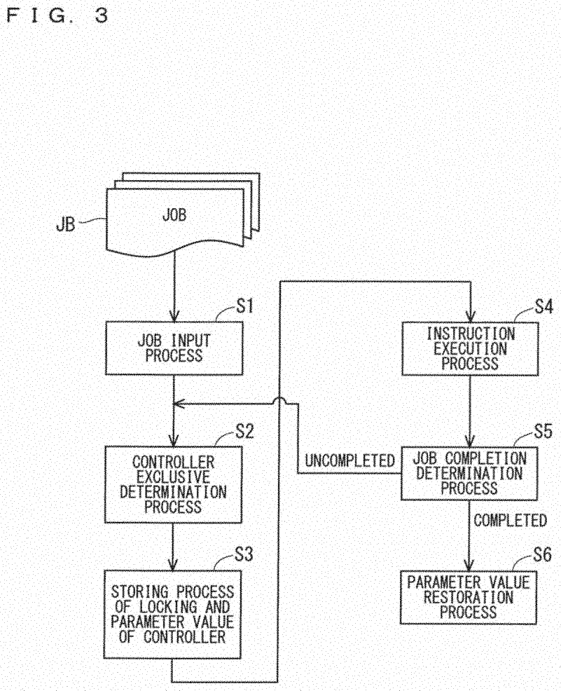

Next, the processing flow in the control management device 100 will be described using the flowchart illustrated in FIG. 3 with reference to FIGS. 1 and 2.

First, a job input process is performed in which the job input unit 10 takes in a job JB including a series of instructions to the manufacturing devices 1 to 3 (Step S1). The instructions included in the job JB are transmission destination information that can be interpreted by the control management device 100 in order for the control management device 100 to transmit instructions to the manufacturing devices 1 to 3, and contents of instructions that can be interpreted and executed by the manufacturing devices 1 to 3.

The form of the content of instruction can be described by external input-output instructions provided by the controllers 1a to 3b that control the manufacturing devices 1 to 3. The external input-output instructions are, for example, a command that directly specifies a memory or a parameter in the controller to read or write data. It can also directly manipulate the values of variables in the user program. They are provided by controller makers as the functions of the controllers 1a to 3b. Also, they can also be described by the content interpreted and executed by the user program processed in the controllers 1a to 3b of the manufacturing devices 1 to 3. When they are described by the content to be interpreted and executed by a user program, for example, a method of a specific user program processing input data can be adopted. In this case, there is an advantage in that the timing of processing in the user program can be controlled. Even in the latter case, to input to the controllers 1a to 3b is to use methods provided as functions of the controllers 1a to 3b, such as data transfer.

Also, the instructions in the job JB are written so that the processing order can be understood. For example, there is a method in which the instructions are listed in order of processing, or a method in which each instruction is numbered according to the processing order. The job JB can comprise an instruction to only one manufacturing device or one controller, and can also comprise instructions to a plurality of manufacturing devices or a plurality of controllers.

In the first embodiment, it will be explained that the job JB includes instructions to a plurality of controllers, each instruction is written in order of processing order in the job JB, and all the processes in the job JB are to be executed. In addition, although the control management device of the present disclosure parallelly executes a plurality of jobs, a flow of processing one job will be described in the descriptions of the first to fourth embodiments.

Here, the method of parallelly executing jobs is the same as the generally known multitask processing method. For example, there is a scheme based on the priority of each job. The priority is set for each job and the process is executed from the job with the highest priority. However, if a job interrupts processing until an external input signal or a specific memory satisfies a certain condition, the processing of the job is interrupted and processing of the job with the next highest priority is started. When the external input signal or the specific memory satisfies the certain condition and the job with high priority can resume processing, the ongoing processing of the low-priority job is interrupted and the processing of the job with the high priority is executed. As another example, there is also a method in which job processing is divided into preset processing units, where one processing unit of each job is completed and then one processing unit of another job is executed. The processing unit is represented, for example, by the processing of each functional unit in FIG. 1. In this method, a plurality of jobs can be virtually and simultaneously executed. In addition to this, there are various methods for parallel execution, and any method is acceptable.

Next, in the controller exclusive determination unit 11, a controller exclusive determination process is executed (Step S2) in which, whether or not the controller, for example, the controller 1a, which is the target of the instruction included in the job JB, is locked is determined due to an ongoing exclusive process by another job. The determination of whether or not the controller 1a is locked may be based on information recorded by the controller 1a locked by the control management device itself, or refer to the memory that the controllers 1a to 3b of the manufacturing device have that manages the lock state. Here, an instruction to be processed next in the job JB is referred to as a process target instruction. In other words, the process target instruction indicates an instruction of the highest processing order among the instructions which have not finished processes in the job JB yet.

The controller exclusive determination process is performed on the process target instruction. When it is determined that the controller 1a, being the target of the instruction, is locked, the controller exclusive determination unit 11 suspends processing of the job JB and waits for the controller 1a to be unlocked. On the other hand, when it is determined that the controller 1a is not locked, the process proceeds to Step S3.

When the controller exclusive determination unit 11 determines that the controller a is locked, and the controller 1a is unlocked, the process proceeds to Step S3.

The parameter value storage 12 performs lock determination to determine whether or not the process target instruction is a writing process of the exclusive process, and when the process target instruction is the writing process of the exclusive process, executes a parameter value storing process in which a parameter value before writing of the controller 1a being a writing destination is stored and locking of the controller 1a (Step S3).

The exclusive process is a process which is executed to prevent the process of the job JB from affecting the process of the other jobs. In Step S3, first, the controller 1a is locked. By locking, instructions by the other jobs to the controller 1a are eliminated. In a system where one controller accepts only one lock and the controller 1a has already been locked by the job JB, there is no need to lock it again. However, if a system manages multiple locks for the controllers 1a to 3b, or one which does not exclude application to a system manages the order of a plurality of locks, and in such cases, it is applicable by performing a plurality of locking operations.

Then, the data value of the writing destination controller 1a (hereinafter referred to as the original data value) is stored in the storage device (not illustrated) in the control management device 100 before executing the writing process in Step S4.

The writing targets here are data that the user can write to the controller 1a, such as parameter values included in the system settings of the controller 1a, variable values in the user program, and user programs.

The information of locking of the controller 1a can be managed by the controller 1a, or by both the control management device 100 and the controller 1a. Also, the original data values can also be stored in the controller 1a.

Note that if the parameter value storage 12 determines that the process target instruction is not the exclusive process, even if it is a parameter value writing process, the parameter value storage 12 does nothing and shifts to the process in Step S4.

In the above description, although the writing process is given as an example of the exclusive process, the exclusive process can also be designated with a process other than the writing process. In that case, the parameter value storage 12 only locks the controller 1a without storing the original data values.

The instruction execution unit 13 executes an instruction execution process that executes the process target instruction (Step S4). The instruction execution unit 13 transmits the content of the instruction to the destination controller 1a based on the transmission destination information included in the instruction. The instruction content is written in a format that can be interpreted by the manufacturing device to which the instruction is sent; therefore, the instruction content does not need to be in a format that can be interpreted by the control management device 100. The control management device 100 receives an instruction completion report from the destination and proceeds to the next process.

Instead of waiting for the instruction completion report from the destination, the control management device 100 can receive an instruction reception report from the destination and proceed to the next process. With this, in the case of instruction content taking a long time to complete the instruction, the instructions in the job that can be parallelly executed can be continuously processed without waiting for the completion of the instruction.

Also, the process can proceed to the next process without waiting for any response from the destination. This eliminates the need to wait for a response when the instruction content is simple, thus shortening the processing time.

The transition can be determined based on the determination criteria fixedly set in the control management device 100, or can be determined based on the transition determination criteria specified by each job or each instruction. An Example where the transition criteria are specified in the instructions is: Instruction 1 and Instruction 2 do not wait for responses from the destination, Instruction 3 waits for a reception report from the destination, and Instruction 4 waits for completion report from the destination and so forth.

The job completion determination unit 14 determines whether or not the process target instruction processed by the instruction execution unit 13 is the last instruction in the job JB (Step S5). If it is not the last instruction in the job JB, the job completion determination unit 14 specifies the instruction following the current process instruction in the execution order as the new process instruction, proceeds to the process after the job input section 10, and executes the remaining instructions in the job JB continuously. On the other hand, if the process target instruction is the last instruction in the job JB, the process proceeds to Step S6.

The parameter value restoration unit 15 executes a parameter value restoration process for restoring the data value in the memory held by the controller 1a to the original data value (Step S6), and unlocks the controller 1a. The parameter value restoration unit 15 first writes the data value stored as the original data value in the parameter value storage 12 into the controller 1a to restore the parameter value before the job execution. After that, the parameter value restoration unit 15 unlocks the controller 1a to be opened for the instruction to the controller 1a by another job. When all the original data values stored by the instructions in the job JB have been restored and all locks have been released, the series of processes of the job JB is completed. Here, the restoration of the parameter values is performed in the reverse order of the execution order of the instructions, so that restoration is ensured even if a plurality of inputs are made to one parameter.

If the parameter value storage 12 does not execute the original data value storage process, the parameter value restoration unit 15 completes the series of processes of the job JB without executing the parameter value restoration process.

As described above, in the control management device 100, the exclusive process of parallelly executed jobs is ensured by locking the instruction target controller 1a which the exclusive process is specified. In addition, in a writing instruction which the exclusive process is specified, suppression of the influence on other jobs is ensured by storying and restoring the original data values. Furthermore, by locking the controllers and storing the original data values in the control management device 100, functions can be implemented without adding special functions to each controller.

In the above description, although the controller 1a is locked after the parameter value storage 12 performs the lock determination of the process target instruction, the lock determination can also be performed at the beginning of the job JB. That is, instead of performing the lock determination individually for each instruction of job JB, the lock determination may be performed for all instructions in job JB when processing the first instruction included in the job. Furthermore, when the process in the parameter value storage 12 is executed at first in each job, all controllers to be locked by instructions in the job JB are extracted, so that all controllers can be locked. However, the parameter values are stored when each instruction becomes a process target instruction. Also, when a plurality of simultaneous locking are performed, the process proceeds to the next process after all the locking are completed. That is, if a controller locked by another job is included in the locking target, waiting is required for the lock to be released.

Also, the locking targets are not limited to the controllers 1a to 3b. For example, instead of one controller, the entire manufacturing device or a plurality of manufacturing devices, a specified program, a specified memory range, or the like may be locking targets. Furthermore, the instruction content can be specified such that only the writing process, only the reading process, both the writing and reading processes, or only the specified process, is to be locking targets. When specifying the instruction content of the locking target, the controller exclusive determination unit 11 performs the controller exclusive determination process (S2) including the instruction content of the process target instruction.

In this manner, with the writing instruction which the exclusive process is specified, as well as storing and restoring the original data value are performed, the exclusive process of parallelly executed jobs is ensured by locking the instruction target controller which the exclusive process is specified.

### SECOND EMBODIMENT

<Device Configuration>

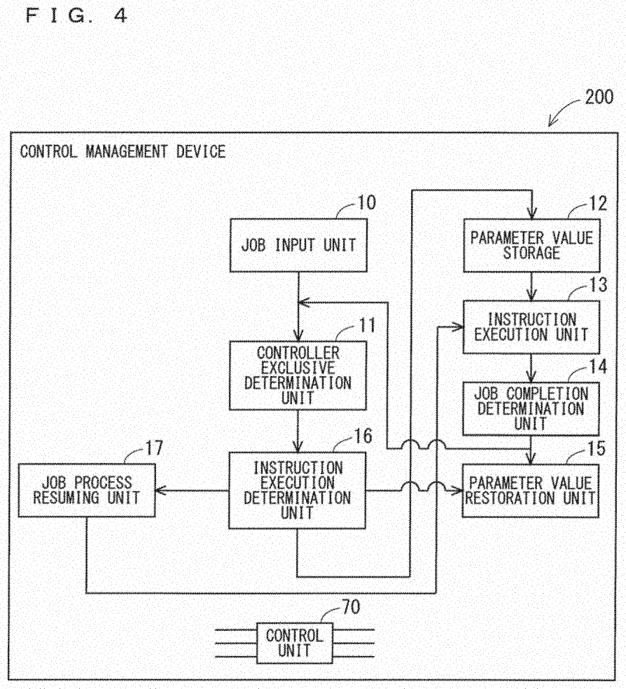

FIG. 4 is a functional block diagram illustrating a configuration of a control management device 200 of a second embodiment. In FIG. 4, the same components as those of the control management device 100 described with reference to FIG. 2 are denoted by the same reference numerals, and overlapping descriptions are omitted.

As illustrated in FIG. 4, in addition to the configuration of the control management device 100 illustrated in FIG. 2, the control management device 200 includes an instruction execution determination unit 16 that determines whether or not instructions to the controller 1a to 3b are executable in the controller 1a to 3b, and a job process resuming unit 17 that operates based on the determination result of the instruction execution determination unit 16.

<Operation>

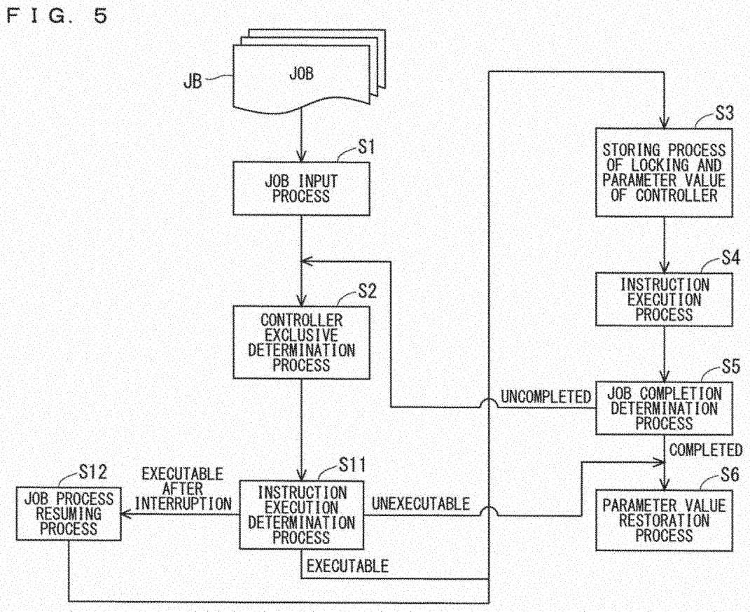

Next, the processing flow in the control management device 200 will be described using the flowchart illustrated in FIG. 5 with reference to FIGS. 1 and 4.

After the controller exclusive determination process (Step S2) in the controller exclusive determination unit 11, the instruction execution determination unit 16 executes an instruction execution determination process in which whether or not the process target instruction is executable at the current point in the controller that is the process target instruction, for example, the controller 1a (Step S11) is determined. When it is determined to be executable, the processes from Step S3 onwards are executed as in the first embodiment. Here, whether or not the process target instruction is executable in the controller 1a which the instruction target is specified based on the reply of the confirmation instruction about executability to the controller 1a or the value of the memory that the controller 1a opens to the outside. Note that the case where the process target instruction is unexecutable includes a state in which the controller 1a is performing another operation with being in a state of not accepting any instruction from the outside.

On the other hand, if it is determined to be unexecutable, the process proceeds to a parameter value restoration process (Step S6), the data values changed in the job JB are restored based on the original data values, the controller 1a locked by the parameter value storage 12 is released, and the execution of the process target instruction is canceled. Note that if the original data value is not stored or locked by an instruction executed before the process target instruction in the job JB, the parameter value restoration unit 15 does nothing.

Thereafter, the control management device 200 waits in the controller exclusive determination unit 11 and the instruction execution determination unit 16 until the process target instruction becomes executable in the controller 1a. When the instruction execution determining unit 16 determines that the cancelled process target instruction to be executable in the controller 1a that is the instruction target, the process proceeds to a job process resuming process (Step S12) in the job process resuming unit 17.

The job process resuming unit 17 returns to the state of the process target instruction canceled in the instruction execution determining unit 16, and causes the process target instruction to be executed. First, the job process resuming unit 17 re-executes the process from Step S3 onwards according to the processing order of the exclusive process instruction executed before the process target instruction in the job JB, and restores the job JB interrupted due to the cancellation of the process target instruction. to its pre-interruption state. After that, the job JB is resumed by executing the processes from Step S3 onward for the process target instruction. The job process resuming unit 17, for example, sequentially executes the exclusive process based on the information of the exclusive process in the job JB executed before the process target instruction which the control management device 200 has recorded, or registers a job of the compiled exclusive processes to be executed before the process target instruction based on the information of all the instructions and the order information of the process target instruction included in the job JB, or the like, to return to its pre-cancellation state.

According to the control management device 200 of the second embodiment, by providing the instruction execution determination unit 16 and the job process resuming unit 17, if it is determined that the process target instruction is unexecutable in the controller 1a, the controller 1a locked by the parameter value storage 12 is unlocked and prioritize the processes of other jobs; therefore, processes of a plurality of jobs can be processed efficiently, and overall suppression of delaying of processes when a plurality of jobs are being parallelly executed. Also, the occurrence of deadlock can be suppressed.

### THIRD EMBODIMENT

<Device Configuration>

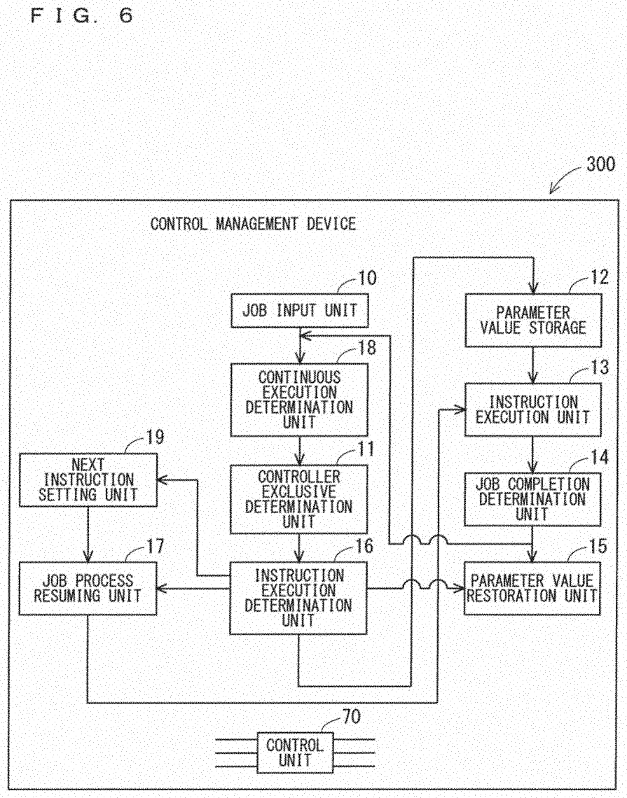

FIG. 6 is a functional block diagram illustrating a configuration of a control management device 300 of a third embodiment. In FIG. 6, the same components as those of the control management device 200 described with reference to FIG. 4 are denoted by the same reference numerals, and overlapping descriptions are omitted.

As illustrated in FIG. 6, in addition to the configuration of the control management device 200 illustrated in FIG. 4, the control management device 300 includes a continuous execution determination unit 18 to which a job fetched by the job input unit 10 is input, and a next instruction setting unit 19 that sets a process target instruction to be resumed when the job JB is interrupted.

<Operation>

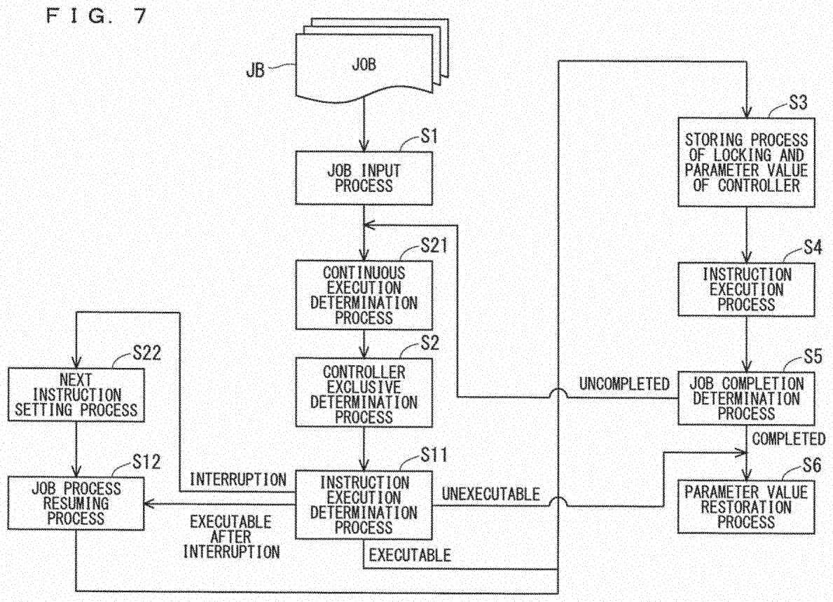

Next, the processing flow in the control management device 300 will be described using the flowchart illustrated in FIG. 7 with reference to FIGS. 1 and 6.

After the job input process (Step S1) in the job input unit 10, or after the job completion determination process (Step S5) determines that the job is uncompleted, the continuous execution determination unit 18 performs a continuous execution determination process (Step S21) in which whether or not the process target instruction is a continuous execution target. In the continuous execution determination process, first, it is determined whether or not the process target instruction is an instruction to start continuous execution, and when it is an instruction to start the continuous execution, a process processing instruction is registered as a resuming candidate instruction that specifies an instruction for resuming in the job process resuming unit 17 after the job JB has been interrupted in the instruction execution determination unit 16. Further, when the process target instruction is an instruction following the instruction to end the continuous execution, the registration of the resuming candidate instruction is deleted. After executing the continuous execution determination process, the processes from Step S2 onwards are executed.

When the job JB is interrupted in the instruction execution determination unit 16, the next instruction setting unit 19 executes a next instruction setting process (Step S22) in which the process target instruction to be resumed is set to the instruction registered in the resuming candidate instruction. The next instruction setting process is executed continuously after the process of interrupting the job JB by the instruction execution determination unit 16, and when the process target instruction being continuously executed is interrupted, and the resuming candidate instruction is registered in the continuous execution determination unit 18, the process target instruction of the job JB is set to the instruction registered in the resuming candidate instruction. When resuming the processing of the job JB, the job process resuming unit 17 resumes the process from the process target instruction set by the next instruction setting unit 19. Note that the next instruction setting unit 19 does not change the process target instruction when there is no registration in the resuming candidate instruction.

According to the control management device 300 of the third embodiment, by providing the continuous execution determining unit 18 and the next instruction setting unit 19, when the process in the job JB is interrupted by the instruction execution determining unit 16, and resuming the interrupted job JB in the job process resuming unit 17, the process target instruction to resume can be specified, and ensuring appropriate processing of a plurality of instructions to be processed continuously within a certain period of time. For example, when data values from a plurality memories in the controller are read out within a certain period of time, and a series of reading processes is interrupted during execution, with the process target instruction being specified to resume from the first memory reading processing, the reading processing can be resumed from the first memory.

### FOURTH EMBODIMENT

<Device Configuration>

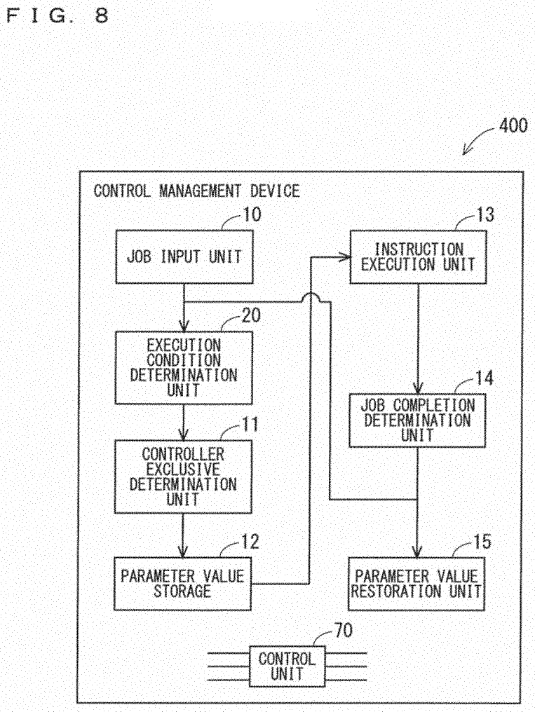

FIG. 8 is a functional block diagram illustrating a configuration of a control management device 400 of a fourth embodiment. In FIG. 8, the same components as those of the control management device 100 described with reference to FIG. 2 are denoted by the same reference numerals, and overlapping descriptions are omitted.

As illustrated in FIG. 8, in addition to the configuration of the control management device 100 illustrated in FIG. 2, the control management device 400 includes an execution condition determination unit 20 to which a job fetched by the job input unit 10 is input.

<Operation>

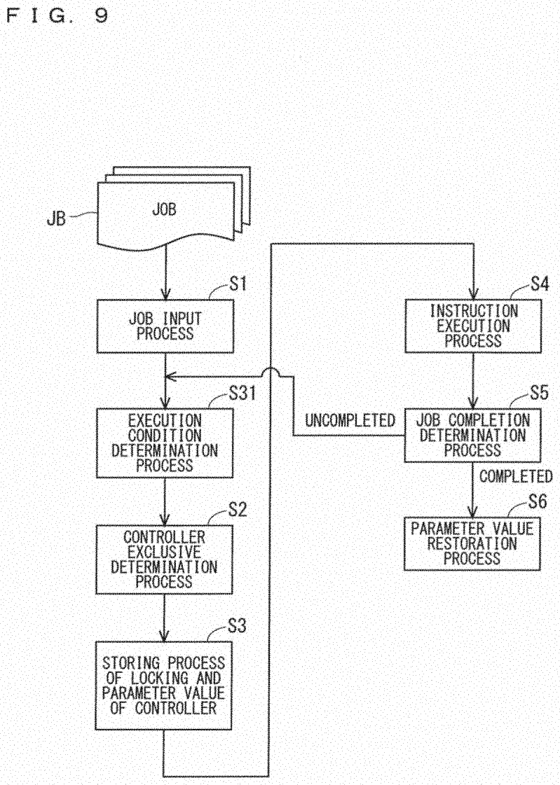

Next, the processing flow in the control management device 400 will be described using the flowchart illustrated in FIG. 9 with reference to FIGS. 1 and 8.

After the job input process (Step S1) in the job input unit 10, or after the job is determined to be uncompleted in the job completion determination process (Step S5), the execution condition determination unit 20 determines the execution condition of each instruction specified in the job JB (Step S31), and changes the process target instruction based on the determination result.

The execution condition determination unit 20 first determines the execution condition given to the process target instruction in the job JB. An execution condition includes an execution condition determination expression and an execution condition process. The execution condition determination expression is, for example, a determination expression that compares a value of a specified variable managed by controllers 1a to 3b or control management device 400 with a specified value, and, the execution condition process is executed based on the determination result of the execution condition determination expression.

The execution condition is written in the same format as, for example, an if statement in a programming language. For example, if a memory ×1000 of the controller 1a is on, and “instruction 1” is executed, otherwise “instruction 2” is executed, it is written as follows: if ×1000==ON Then “instruction 1” else “instruction 2”. In the writing example, “instruction 1” and “instruction 2” are the execution condition processes, and the rest is the execution condition determination expression. In addition to execution of the process target instruction, in the execution condition process, contents such as waiting until the result of the execution condition determination expression changes to a specific result, waiting for a specific time and re-determining, and the like, are written.

After transitioning to execution of the process target instruction in the execution condition determination unit 20, the process proceeds from Step S2 onwards as in the first embodiment.

According to the control management device 400 of the fourth embodiment, by providing the execution condition determination unit 20, the execution condition for each instruction in the job can be set and the job JB having a complicated processing procedure can be executed. For example, by setting the execution condition according to the state of the controller, the execution of the job JB having a complicated procedure is ensured.

<Hardware Configuration>

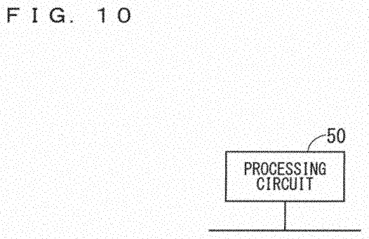

Each component of the control management devices 100, 200, 300 and 400 of the above-described first to fourth embodiments can be configured using a computer, and is implemented by the computer executing the program. That is, the control management devices 100 to 400 are implemented by, for example, a processing circuit 50 illustrated in FIG. 10. A processor such as a Central Processing Unit (CPU) or a Digital Signal Processor (DSP) is applied to the processing circuit 50, and the function of each part is implemented by executing a program stored in the storage device.

Dedicated hardware may also be applied to the processing circuit 50. When the dedicated hardware is applied to the processing circuit 50, a processing circuit 50 corresponds, for example, to a single circuit, a composite circuit, a programmed processor, a parallel programmed processor, an Application Specific Integrated Circuit (ASIC), or a Field-Programmable Gate Array (FPGA), or the combination thereof.

In the control management devices 100 to 400, each function of the components may be implemented by individual processing circuits, or these functions may be collectively implemented by one processing circuit.

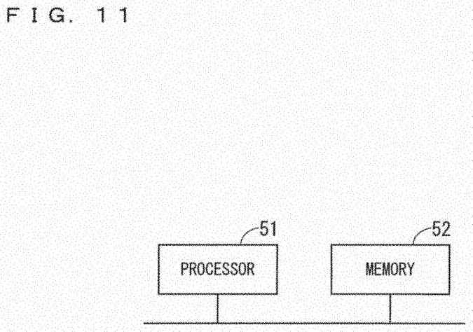

Further, FIG. 11 illustrates a hardware configuration when the processing circuit 50 is configured using a processor. In this case, the function of each unit of the control management devices 100 to 400 is implemented in combination with software, (software, firmware, or software and firmware) etc. Software etc. is written as a program and stored in the memory 52. A processor 51 that functions as the processing circuit 50 implements the function of each part by reading and executing the program stored in the memory 52 (storage device). That is, it can be said that this program causes the computer to execute the procedure and method of operation of the components of the control management devices 100 to 400.

Here, the memory 52 may be, for example, a non-volatile or volatile semiconductor memory, such as a RAM, a ROM, a flash memory, an Erasable Programmable Read Only Memory (EPROM), an Electrically Erasable Programmable Read Only Memory (EEPROM), or the like, a HDD (Hard Disk Drive), a magnetic disk, a flexible disk, an optical disk, a compact disk, a digital versatile disc (DVD) and a drive therefor or the like, or any storage medium used in the future.

The configuration in which the function of each component of the control management devices 100 to 400 is implemented by either hardware or software has been described above. However, the configuration is not limited thereto, a configuration in which some components of the control management devices 100 to 400 are implemented by dedicated hardware and some other components are implemented by software or the like may be adoptable. For example, for some components, the functions are implemented by the processing circuit 50 as dedicated hardware, and for some other components, the functions are implemented by the processing circuit 50 as the processor 51 reading and executing the program stored in the memory 52.

Accordingly, the control manages devices 100 to 400 can implement the above each function by hardware, software, firmware, or a combination thereof.

While the disclosure has been described in detail, the foregoing description is in all aspects illustrative and not restrictive. It is understood that numerous other modifications not having been described can be devised without departing from the scope of the disclosure.

In the present disclosure, the embodiments of the present disclosure can be combined, appropriately modified or omitted, without departing from the scope of the disclosure.

1. A control management device comprising:
a job input circuitry into which a job including a plurality of instructions to a controller is input;
a controller exclusive determination circuitry configured to determine whether or not the controller which is a target of an instruction included in the job is locked due to an ongoing exclusive process by another job, and, when the controller is locked, wait for the controller to be unlocked;
a parameter value storage configured to, when an instruction to be executed next is writing of an exclusive process, store a value of writing target in the controller as an original data value and lock the controller;
an instruction execution circuitry configured to notify the controller of the instruction to be executed next in the job and cause the instruction be executed by the controller;
a job completion determination circuitry configured to determine whether or not all instructions in the job have been completed; and
a parameter value restoration circuitry configured to restore the original data value to the controller after all the instructions in the job have been completed and unlock the controller.

2. The control management device according to claim 1, further comprising:
an instruction execution determination circuitry configured to determine whether or not the instruction to be executed next in the job is executable by the controller after the controller is locked in the parameter value storage, restore the original data value to the controller in the parameter value restoration circuitry when determined as being unexecutable, and cancel the instruction to be executed next by unlocking the controller; and
a job process resuming circuitry configured to resume execution of the job that has been interrupted by the cancellation of the instruction to be executed next when the instruction to be executed next in the job becomes executable in the controller.

3. The control management device according to claim 2, wherein
the job process resuming circuitry is configured to re-execute the instruction of the exclusive process executed before the instruction to be executed next in the job according to the processing order, and cause the instruction to be executed next to be executed after restoring the job that has been interrupted by the cancellation of the instruction to be executed next to pre-interruption to resume execution of the job.

4. The control management device according to claim 2, further comprising:
a continuous execution determination circuitry configured to determine whether or not the instruction to be executed next in the job is a start of continuous execution, and when determined as being a start of the continuous execution, after the job has been interrupted in the instruction execution determination circuitry, register a resuming candidate instruction for resuming in the job process resuming circuitry; and
a next instruction setting circuitry configured to set the resuming candidate instruction registered in the continuous execution determination circuitry to the instruction to be execute next when the job has been interrupted in the instruction execution determination circuitry.

5. The control management device according to claim 1, further comprising an execution condition determination circuitry configured to determine an execution condition given to the instruction to be executed next in the job, and change the instruction to be executed next based on a determination result.

6. The control management device according to claim 5, wherein
the execution condition includes an execution condition determination expression and an execution condition process, and
the execution condition determination expression includes a determination expression that compares a value of a specified variable managed by the controller or the control management device with a specified value, and, the execution condition process is executed based on the determination result of the execution condition determination expression.
